(19) United States
(12) Patent Application Publication
(10) Pub. No.: US 2011/0269909 A1
(43) Pub. Date: Nov. 3, 2011

(54) MANUFACTURE OF PERFLUOROELASTOMER COMPOUNDS CONTAINING FIBRILLATING PTFE

(75) Inventor: CHRISTOPHER JOHN BISH, Kennett Square, PA (US)

(73) Assignee: E.I. DU PONT DE NEMOURS AND COMPANY, Wilmington, DE (US)

(21) Appl. No.: 12/769,886

(22) Filed: Apr. 29, 2010

(51) Int. Cl. C08F 8/00

(52) U.S. Cl. 525/195; 525/192; 525/194

(57) ABSTRACT

Curable perfluoroelastomer compounds are prepared by mixing a composition comprising perfluoroelastomer, 1-20 phr fibrillating PTFE, and curative for a time M_{L} (ASTM D5289), measured on sequential samples of compound taken at 5 minute intervals, differ by less than 5%. Articles are made therefrom by curing the compounds to form crosslinks.

### FIELD OF THE INVENTION

The present invention relates to the manufacture of perfluoroelastomer compounds that contain 1 to 20 parts by weight fibrillating PTFE, per hundred parts perfluoroelastomer, and to cured articles made therefrom.

### BACKGROUND OF THE INVENTION

Perfluoroelastomers have achieved outstanding commercial success and are used in a wide variety of applications in which severe environments are encountered, in particular those end uses where exposure to high temperatures and aggressive chemicals occurs. For example, these polymers are often used in seals for aircraft engines, in oil-well drilling devices, and in sealing elements for industrial equipment used at high temperatures.

The outstanding properties of perfluoroelastomers are largely attributable to the stability and inertness of the copolymerized perfluorinated monomer units that make up the major portion of the polymer backbones in these compositions. Such monomers include tetrafluoroethylene and perfluorinated vinyl ethers. In order to develop elastomeric properties fully, perfluoroelastomers are typically crosslinked, i.e. vulcanized. To this end, a small amount of cure site monomer is copolymerized with the perfluorinated monomer units. Cure site monomers containing at least one nitrile group, for example perfluoro-8-cyano-5-methyl-3,6-dioxa-1-octene, are especially preferred. Such compositions are described in U.S. Pat. Nos. 4,281,092; 4,394,489; 5,789,489; and 5,789,509.

Perfluoroelastomer articles often contain carbon black, mineral, or non-fibrillating fluoroplastic fillers in order to achieve a suitable modulus or hardness for end use environments. Fluoroplastic fillers are preferred for some end uses, e.g. semiconductor manufacturing, where perfluoroelastomer seals are exposed to reactive plasmas. The plasma erodes the perfluoroelastomer polymer and any non-fibrillating fluoroplastic filler. However, seals that contain inorganic fillers release filler as polymer is eroded and the filler may contaminate the semiconductor.

High loading (e.g. >30 parts by weight per hundred parts perfluoroelastomer) of non-fibrillating fluoroplastic filler is required in order to achieve perfluoroelastomer articles having the desired modulus and hardness. Unfortunately, the higher the loading of non-fibrillating fluoroplastic filler, the higher the compression set resistance of the perfluoroelastomer article. Low values of compression set resistance are desirable for achieving leak-free sealing.

U.S. Pat. No. 4,520,170 discloses compounds of perfluoroelastomer with 1 to 40 parts by weight, per hundred parts perfluoroelastomer, of fibrillating poly(tetrafluoroethylene) (i.e. ‘PTFE’). The compounds are made by cryogenically pulverizing blends of perfluoroelastomer and fibrillating PTFE into a powder.

It would be desirable to have a perfluoroelastomer composition which, when crosslinked, provides the combination of good sealing properties, sufficient strength for use in semiconductor manufacturing equipment, and which releases few particles after exposure to reactive plasmas. It would further be desirable to only employ conventional rubber processing equipment in the manufacture of the compositions, i.e. not cryogenic grinding.

### SUMMARY OF THE INVENTION

An aspect of this invention is a process for the manufacture of a curable perfluoroelastomer compound, said process comprising mixing i) a perfluoroelastomer comprising copolymerized units of tetrafluoroethylene, a perfluorinated vinyl ether, and nitrile group-containing cure site monomer, ii) 1 to 20 parts by weight per hundred parts by weight perfluoroelastomer of a fibrillating PTFE, and iii) a curative to form a curable compound, said mixing carried out for a time until M_{L} (ASTM D5289), measured on sequential samples of compound taken at 5 minute intervals, differ by less than 5%.

Another aspect of this invention is a process for preparing a cured article, said process comprising:
A. mixing i) a perfluoroelastomer comprising copolymerized units of tetrafluoroethylene, a perfluorinated vinyl ether, and nitrile group-containing cure site monomer, ii) 1 to 20 parts by weight per hundred parts by weight perfluoroelastomer of a fibrillating PTFE, and iii) a curative to form a curable compound, said mixing carried out for a time until M_{L} (ASTM D5289), measured on sequential samples of compound taken at 5 minute intervals, differ by less than 5%; and
B. curing said compound to form a crosslinked article.

### DETAILED DESCRIPTION OF THE INVENTION

Perfluoroelastomers are generally amorphous polymeric compositions having copolymerized units of at least two principal perfluorinated monomers. One of the principal monomers is a perfluoroolefin while the other is a perfluorovinyl ether. Representative perfluorinated olefins include tetrafluoroethylene and hexafluoropropylene. Suitable perfluorinated vinyl ethers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluorinated vinyl ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms. Most preferred perfluorinated vinyl ethers are those wherein n is 0 or 1 and R_{f} contains 1-3 carbon atoms. Examples of such perfluorinated ethers include perfluoro(methyl vinyl ether) and perfluoro(propyl vinyl ether).

Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluorinated vinyl ether monomers include compounds of the formula

CF₂═CFO[(CF₂CFCF₃O)ₙ(CF₂CF₂CF₂O)ₘ(CF₂)ₚ]CₓF₂ₓ₊₁ (IV)

where m and n=1-10, p=0-3, and x=1-5. Preferred members of this class include compounds where n=0-1, m=0-1, and x=1.

Additional examples of useful perfluorinated vinyl ethers include

CF₂═CFOCF₂CF(CF₃)O(CF₂O)ₘCₙF₂ₙ₊₁ (V)

where n=1-5, m=1-3, and where, preferably, n=1.

Preferred perfluoroelastomer copolymers are comprised of tetrafluoroethylene and at least one perfluorinated vinyl ether as principal monomer units. In such copolymers, the copolymerized perfluorinated ether units constitute from about 15-50 mole percent of total monomer units in the polymer.

The perfluoroelastomer further contains copolymerized units of at least one nitrile group-containing cure site monomer, generally in amounts of from 0.1-5 mole percent. The range is preferably between 0.3-1.5 mole percent. Suitable cure site monomers include nitrile-containing fluorinated olefins and nitrile-containing fluorinated vinyl ethers. Useful nitrile-containing cure site monomers include those of the formulas shown below.

CF₂═CF—O(CF₂)ₙ—CN (VI)

where n=2-12, preferably 2-6;

CF₂═CF—O[CF₂—CF(CF₃)—O]ₙ—CF₂—CFCF₃—CN (VII)

where n=0-4, preferably O-2; and

CF₂═CF—[OCF₂CF(CF₃)]ₓ—O—(CF₂)ₙ—CN (VIII)

where x=1-2, and n=1-4.

Those of formula (VIII) are preferred. Especially preferred cure site monomers are perfluorinated polyethers having a nitrite group and a trifluorovinyl ether group. A most preferred cure site monomer is

CF₂═CFOCF₂CF(CF₃)OCF₂CF₂CN (IX)

i.e. perfluoro(8-cyano-5-methyl-3,6-dioxa-1-octene) or 8-CNVE.

An especially preferred perfluoroelastomer comprises copolymerized units of 53.0-79.9 mole percent tetrafluoroethylene, 20.0-46.9 mole percent perfluoro(methyl vinyl ether) and 0.4 to 1.5 mole percent of a nitrile group-containing cure site monomer. Mole percentages are based on total moles of all copolymerized monomer units in the perfluoroelastomer.

Fibrillating poly(tetrafluoroethylene) (PTFE) is well known. It is generally a high molecular weight PTFE that forms short (i.e. 1 mm) fibrils when exposed to shear during mixing. For the purposes of this invention, the term “fibrillating PTFE” includes PTFE which has already been fibrillated prior to addition to the compositions of this invention.

Curable compositions and cured articles made by the process of this invention comprise perfluoroelastomer, 1 to 20 (preferably 8 to 12) phr of fibrillating PTFE and a curative. The term “phr” refers to parts by weight of ingredient per hundred parts by weight rubber (i.e. perfluoroelastomer). More than 20 phr fibrillating PTFE causes the compositions to be virtually non-processible, while less than 1 phr fibrillating PTFE results in compositions having negligible reinforcement.

Since the perfluoroelastomer has copolymerized units of a nitrile-containing cure site monomer, a cure system based on an organotin compound can be utilized. Suitable organotin compounds include allyl-, propargyl-, triphenyl- and allenyl tin curatives. Tetraalkyltin compounds or tetraaryltin compounds are the preferred curing agents for use in conjunction with nitrile-substituted cure sites. The amount of curing agent employed will necessarily depend on the degree of crosslinking desired in the final product as well as the type and concentration of reactive moieties in the perfluoroelastomer. In general, about 0.5-10 parts by weight per 100 parts elastomer (phr) of curing agent can be used, and 1-4 phr is satisfactory for most purposes. It is believed that the nitrile groups trimerize to form s-triazine rings in the presence of curing agents such as organotin, thereby crosslinking the perfluoroelastomer. The crosslinks are thermally stable, even at temperatures of 275° C. and above.

Other preferred cure systems utilize bis(aminophenols) or bis(aminothiophenols) of the formulas

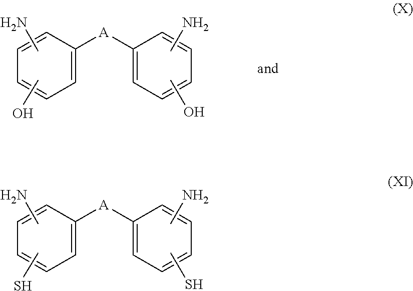

or tetraamines of the formula

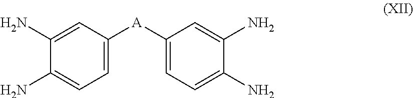

where A is SO₂, O, CO, alkylene of 1-6 carbon atoms, perfluoroalkylene of 1-10 carbon atoms, or a carbon-carbon bond linking the two aromatic rings. The amino and hydroxyl or thio groups in formulas X and XI above are adjacent to each other on the benzene rings and are interchangeably in the meta and para positions with respect to the group A. Preferably, the curing agent is a compound selected from the group consisting of 4,4′-[2,2,2-trifluoro-1-(trifluoromethyl)ethylidene]bis(2-aminophenol); 4,4′-sulfonylbis(2-aminophenol); 3,3′-diaminobenzidine; and 3,3′,4,4′-tetraaminobenzophenone. The first of these is the most preferred and will be referred to as bis(aminophenol) AF (or DABPAF). The curing agents can be prepared as disclosed in U.S. Pat. No. 3,332,907 to Angelo. Bis(aminophenol) AF can be prepared by nitration of 4,4′-[2,2,2-trifluoro-1-(trifluoromethyl)ethylidene]-bisphenol (i.e. bisphenol AF), preferably with potassium nitrate and trifluoroacetic acid, followed by catalytic hydrogenation, preferably with ethanol as a solvent and a catalytic amount of palladium on carbon as catalyst. The level of curing agent should be chosen to optimize the desired properties of the vulcanizate. In general, a slight excess of curing agent over the amount required to react with all the cure sites present in the perfluoroelastomer is used. Typically, 0.5-5 parts by weight of the curative per 100 parts of elastomer is required. The preferred range is 1-2 phr.

Other preferred curatives suitable for vulcanizing perfluoroelastomers having nitrile cure sites include nitrogen-containing nucleophilic compounds (e.g. diphenylguanidine) as disclosed in U.S. Pat. No. 6,638,999 B2, ammonia, the ammonium salts of inorganic or organic acids (e.g. ammonium perfluorooctanoate) as disclosed in U.S. Pat. No. 5,565,512, and compounds (e.g. urea) which decompose at curing temperatures to produce ammonia as disclosed in U.S. Pat. No. 6,281,296 B1. A further preferred cure system is an organic peroxide and multifunctional coagent as disclosed in U.S. Pat. No. 4,983,680.

In the process of the invention for manufacturing curable perfluoroelastomer compositions, the ingredients (i.e. perfluoroelastomer having nitrile-group cure sites, fibrillating PTFE and curative are mixed on a 2-roll rubber mill or other conventional rubber mixing equipment. A 2-roll mill is preferred. Mixing is continued until the M_{L} of samples of the perfluoroelastomer composition, measured on a moving die rheometer (MDR) according to ASTM D5289, has substantially leveled off, i.e. M_{L} values of sequential compound samples taken 5 minutes apart differ by no more than 5% relative to each other. Mixing time is typically on the order of 15 minutes. If mixing is ceased prior to the M_{L} substantially leveling off, M₁₀₀, the modulus at 100% elongation of, the resulting cured article, may be too high and may also be variable. Mixing for longer than the time required for the M_{L} to substantially level off provides no further benefit. Alternatively, the perfluoroelastomer and fibrillating PTFE may be mixed in the absence of curative for about 15 minutes prior to addition of curative.

Cured articles may then be made from the latter curable composition by, optionally shaping the composition, and then crosslinking (i.e. curing). Optionally the article may also be post cured. The cured perfluoroelastomer articles of this invention have good sealing properties, reduced emission of particles when exposed to reactive plasma and sufficient tensile properties for use in semiconductor manufacturing. The articles are useful in many applications such as seals and gaskets.

### EXAMPLES

### Test Methods

### Cure Characteristics

Cure characteristics were measured using a Monsanto MDR 2000 instrument, according to ASTM D5289, under the following conditions:
Moving die frequency: 1.66 Hz
Oscillation amplitude: 1.0
Temperature: 199° C., unless otherwise noted
Sample size: Disks having diameter of 45 mm, and thickness of 5 mm
Duration of test: 30 minutes

The following cure parameters were recorded:
M_{H}: maximum torque level, in units of dN·m
M_{L}: minimum torque level, in units of dN·m
tₛ1: minutes to 0.04 N·m rise above M_{L}
t_{c}90: minutes to 90% of maximum torque

Test specimens were prepared from elastomer compounded with appropriate additives, as described in the formulations listed in the Examples below. Compounding was carried out on a 2-roll rubber mill. The milled composition was formed into a sheet and a 10 g sample was died out into a disk to form the test specimen.

Cure characteristics were determined by placing a test specimen in the sealed test cavity of the instrument which was maintained under a positive pressure and elevated temperature. A biconical disk was embedded in the test specimen and was oscillated through an arc of 0.5° at the specified frequency, thereby exerting a shear strain on the test specimen. The force at maximum amplitude (torque) required to rotate the disk is proportional to the stiffness (shear modulus) of the rubber. This torque was recorded as a function of time. Because stiffness of a rubber specimen increases during curing, the test provides a measure of curability. A test is completed when the recorded torque either reaches equilibrium or maximum value, or when a predetermined time has elapsed. The time required to obtain a curve is a function of the test temperature and the characteristics of the rubber compound.

### Tensile Properties

Unless otherwise noted, stress/strain properties were measured on test specimens that had been press cured at 199° C. for t_{c}90+5 minutes and then post cured in nitrogen for 26 hours at 305° C. (bis(aminophenol) cure) or for 8 hours at 260° C. (peroxide cure) after a slow ramp up in temperature from room temperature. Physical property measurements were obtained according to methods described in ASTM D 412. The following parameters were recorded:
M₁₀₀, modulus at 100% elongation in units of MPa
T_{B}, tensile strength at break in units of MPa
E_{B}, elongation at break in units of %
Durometer Hardness, Shore A

Compression set of O-ring samples was determined in accordance with ASTM D 395.

### Examples 1-2 and Control A

The perfluoroelastomer (FFKM 1) employed in the Examples and Control A contained copolymerized units of 68.2 mole percent tetrafluoroethylene, 31.0 mole percent perfluoro(methyl vinyl ether) and 0.80 mole percent perfluoro(8-cyano-5-methyl-3,6-dioxa-1-octene) and was prepared according to the general process described in U.S. Pat. No. 5,789,489.

The fibrillating or fibrillated PTFE employed was Teflon® 60 or Teflon® 7A available from DuPont. A non-fibrillating fluoroplastic (Teflon® MP 1600) resin was employed in control compositions.

Compositions of the invention (Examples 1-2) and Control A were made by mixing the perfluoroelastomer, fluoropolymer filler and bis(aminophenol) AF (“DABPAF”) curative on an open 2-roll mill at 40° C. The ingredients, proportions and mixing times are shown in Table I. Curing characteristics and tensile properties were measured according to the Test Methods and are also shown in Table I.

TABLE I

| Formulation, phr | Control A | Sample 1 | Sample 2 |
|---|---|---|---|
| FFKM1 | 100 | 100 | 100 |
| Teflon ® 60 | 0 | 10 | 0 |
| Teflon ® 7A | 0 | 0 | 10 |
| Teflon ® MP1600 | 30 | 0 | 0 |
| DABPAF | 1.75 | 1.75 | 1.75 |
| Cure | | | |
| Characteristics | | | |
| M_{L} 0 minutes | 3.57 | 3.83 | 3.21 |
| mixing, dN · m | | | |
| M_{L} 2 minutes | ND¹ | 3.76 | 3.08 |
| mixing, dN · m | | | |
| M_{L} 5 minutes | ND | 3.33 | 2.72 |
| mixing, dN · m | | | |
| M_{L} 10 minutes | ND | 3.54 | 2.53 |
| mixing, dN · m | | | |
| M_{L} 15 minutes | ND | 3.25 | 2.52 |
| mixing, dN · m | | | |
| Physical | | | |
| Properties | | | |
| Tensile (MPa) | 13.3 | 13.0 | 12.3 |
| Eb (%) | 243 | 222 | 225 |
| M100 | 3.8 | 5.9 | 5.1 |
| Hardness (Shore | 71 | 77 | 76 |
| A) | | | |
| Compression Set | 79.6 | 42.8 | 61.9 |
| 15%, 300° C., 70 | | | |
| hours (%) | | | |

¹Not determined

### Example 3 and Control B

The perfluoroelastomer (FFKM2) employed in Control B contained copolymerized units of 67.23 mole percent tetrafluoroethylene, 32.59 mole percent perfluoro(methyl vinyl ether) and 0.18 mole percent iodine and was prepared according to the general process described in U.S. Pat. No. 6,140,437 except that less perfluoro(methyl vinyl ether) was copolymerized.

The fibrillating PTFE employed was Teflon® 7A available from DuPont. Carbon black was N990 available from Degussa. An organic peroxide (PLC DBPH 68 available from Rhein Chemie) and coagent (triallyl isocyanurate (TAIC DLC-A) available from Harwick Standard Distribution, or trimethallyl isocyanurate (TMAIC) available from MIC-Mitsubishi) were employed as curative.

A composition of the invention (Example 3) and Control B were made by first forming a premix of all ingredients except for organic peroxide and coagent, followed by addition of the latter ingredients. The premix was made by mixing the perfluoroelastomer, fluoropolymer filler and carbon black filler on an open 2-roll mill at room temperature for 15 minutes. The ingredients, proportions and ML values (177° C.) taken at 5 minute intervals are shown in Table II. After mixing for 15 minutes, organic peroxide and coagent were added. Curing characteristics and tensile properties were measured according to the Test Methods and are also shown in Table II.

The ML values of Control B actually increase with mixing time, rather than decrease as do the ML values for compositions of the invention.

TABLE II

| Formulation, phr | Control B | Sample 3 |
|---|---|---|
| FFKM1 | 0 | 100 |
| FFKM2 | 100 | 0 |
| Teflon ® 7A | 6 | 6 |
| N990 | 10 | 10 |
| PLC (DBPH) 68 | 1.5 | 3.0 |
| TAIC | 3.1 | 0 |
| TMAIC | 0 | 2 |
| Cure | | |
| Characteristics | | |
| M_{L} 5 minutes | 0.76 | 3.59 |
| mixing after premix | | |
| formed, dN · m | | |
| M_{L} 10 minutes | 1.15 | 3.29 |
| mixing after premix | | |
| formed, dN · m | | |
| M_{L} 15 minutes | 1.43 | 3.2 |
| mixing after premix | | |
| formed, dN · m | | |
| Physical | | |
| Properties | | |
| Tensile (MPa) | 21.3 | 13.3 |
| Eb (%) | 165 | 148 |
| M100 | 11.1 | 8.1 |
| Hardness (Shore | 83 | 82 |
| A) | | |

What is claimed is:

1. A process for the manufacture of a curable perfluoroelastomer compound, said process comprising
mixing i) a perfluoroelastomer comprising copolymerized units of tetrafluoroethylene, a perfluorinated vinyl ether, and nitrile group-containing cure site monomer, ii) 1 to 20 parts by weight per hundred parts by weight perfluoroelastomer of a fibrillating PTFE, and iii) a curative to form a curable compound, said mixing carried out for a time until M_{L} (ASTM D5289), measured on sequential samples of compound taken at 5 minute intervals, differ by less than 5%.

2. A process of claim 1 wherein 8 to 12 parts by weight per hundred parts by weight perfluoroelastomer of a fibrillating PTFE was employed.

3. A process of claim 1 wherein said curative is selected from the group consisting of organotin compounds, bis(aminophenols), bis(aminothiophenols), tetraamines, nitrogen-containing nucleophilic compounds, compounds that decompose at curing temperatures to produce ammonia and organic peroxides.

4. A process for preparing a cured article, said process comprising:
A. mixing i) a perfluoroelastomer comprising copolymerized units of tetrafluoroethylene, a perfluorinated vinyl ether, and nitrile group-containing cure site monomer, ii) 1 to 20 parts by weight per hundred parts by weight perfluoroelastomer of a fibrillating PTFE, and iii) a curative to form a curable compound, said mixing carried out for a time until M_{L} (ASTM D5289), measured on sequential samples of compound taken at 5 minute intervals, differ by less than 5%; and
B. curing said compound to form a crosslinked article.

5. A process of claim 4 wherein 8 to 12 parts by weight per hundred parts by weight perfluoroelastomer of a fibrillating PTFE was employed.

6. A process of claim 4 wherein said curative is selected from the group consisting of organotin compounds, bis(aminophenols), bis(aminothiophenols), tetraamines, nitrogen-containing nucleophilic compounds, compounds that decompose at curing temperatures to produce ammonia and organic peroxides.
